(19) United States
(12) Patent Application Publication
(10) Pub. No.: US 2024/0346544 A1
(43) Pub. Date: Oct. 17, 2024

(54) METHOD AND SYSTEM FOR AUTOMATIC ADJUSTMENT OF FAN REWARDS IN PERSONALIZED COLLEGE ATHLETE NAME/IMAGE/LIKENESS (NIL) MEDIA BASED ON SELECTED SOCIAL MEDIA PLATFORMS

(71) Applicant: Robert N. Barrett, Huntsville, AL (US)

(72) Inventor: Robert N. Barrett, Huntsville, AL (US)

(21) Appl. No.: 18/747,726

(22) Filed: Jun. 19, 2024

(51) Int. Cl. G06Q 30/0207; G06Q 50/00

(52) U.S. Cl. CPC G06Q 30/0239; G06Q 50/01

(57) ABSTRACT

Disclosed are systems and methods for automatically providing digital rewards to a user based on personalized Name, Image, or Likeness (NIL) media being shared on one or more social media platforms. The personalized NIL media may include, for example, an electronic autograph, an electronic written message, an electronic audio message, an electronic video message, or a combination thereof provided by a college athlete. In select embodiments, a unique identifier may be used to determine a user's social media platform preferences to continually engage them over the athlete's collegiate and/or professional career.

### BACKGROUND OF THE INVENTION

National Collegiate Athletics Association (NCAA) rules previously barred athletes from making money from their Name, Image, or Likeness (NIL). Recent lawsuits have now caused the NCAA to largely remove these long-held restrictions in April of 2024. Parallel to this policy reversal, individual U.S. states have been creating their own Name/Image/Likeness laws to manage how college athletes benefit from their institutional successes.

But athletic success is only half the problem-managing the athlete's public persona is the other. Student athletes are already juggling classes and sports practices. Now they have a third activity managing how their Name, Image, & Likeness is being commercialized. Most of these athletes are young, inexperienced in business, and have no concept of how to monetize these opportunities.

Social media platforms are not interchangeable, many having worked for years to develop unique features or appeal to certain subsets of users. Most platforms are designed for, or become extremely popular with, a particular demographic. For example, Instagram is popular with a younger audience, while Facebook is generally used by an older consumers, yet both are owned and operated together by a parent corporation, Meta.

Most social medial platforms similarly target a particular demographic. TikTok is a short form video site popular with teenagers. LinkedIn in popular among 30-49 year business people, particularly job hunters. YouTube appeals to 18-34 year old adults, more than cable tv now reaches.

Social media platform permissions, preferences, and regulations can vary widely from country to country. While many platforms enjoy a worldwide user base, some have regulations that limit the type or number of customers it can have. For instance Blip.no requires a Norwegian phone number to register, a means of keeping the platform explicitly for the citizens of a single country. But the postings by, from, and to members could come from anywhere in the world, assuming the proper permissions are in place.

College athletes are not in a position to know an individual user's social media preferences in advance. Athletes need a system that permits them to regularly incentivize fans within the constraints of the NCAA, each social media platform's requirements, a user's preferences, and the state regulations of where each college athlete resides.

### SUMMARY OF THE INVENTION

Disclosed are systems and methods for selectively providing electronic rewards to a user (fan) based on personalized NIL media shared on a social media platform. The personalized NIL media may include, for example, an electronic autograph, an electronic written message, an electronic audio message, an electronic video message, or a combination thereof, provided by a college athlete. In select embodiments, a unique identifier may be used to track a user's electronic social media platform preferences to further engage the user in their preferred manner.

In select embodiments, a digital reward is provided to a user based on specific personalized NIL media communicated to a social media platform, the method including: (a) sharing a request from a user's electronic device to a database having stored personalized NIL media; (b) processing, by the database, the request of step (a), the database subsequently sharing the personalized NIL media request to the athlete's electronic device, the requested personalized NIL media having one or more unique identifiers for identifying the personalized NIL media once it is shared on an social media platform; (c) storing the personalized NIL media of step (b) on the user's electronic device; (d) accessing the social media platform with the user's electronic device; (e) sharing the personalized NIL media of step (c) from the user's electronic device to the electronic social media platform such that other users of the platform can view the personalized NIL media; (f) after step (e), communicating into the user's electronic device a reward for sharing the personalized NIL media on the social media platform and also communicating to the database the unique identifier identifying the personalized NIL media; (g) after step (f), identifying, by the database, the personalized NIL media of step (f) by the unique identifier and the specific social media platform with which the personalized NIL media of step (f) was shared; and (h) identifying a user's preferred social media platforms by comparing the personalized NIL media of step (g) with demographic information associated with the user's media device including at least one of age, education level, income, gender, location, nationality, ethnicity, brand preferences, political party affiliation, or any combination thereof. In select embodiments, this may be performed in real time, delivering the reward to the user's electronic device either concurrently or sequentially while communicating to the database the unique identifier specifying the personalized NIL media.

There are numerous applications of this innovation. These could be legal, such as preventing a beer company in Russia from offering a reward, since the advertising of alcohol over the Internet is banned in that country. Another embodiment might be age related, where a movie studio would not want to promote an NC-17 rated movie to preteen viewers. Another embodiment might be cultural, where select promotions would be curtailed during specific times of the year in recognition of national, ethnic, or religious holidays.

In select embodiments, the system can be governed by individual institutions that restrict when, where, and how college athletes can engage in NIL activity. These restrictions may limit the athlete to providing personalized NIL media only on weekends, when classes are presumably not being held, or only after a certain time on weekdays. Restrictions could also be geographic, only permitting NIL activities off campus, when the college athlete is presumed to not be in class. Other academic control measures are also envisioned, including revenue-sharing, preferential queuing for university boosters, and other measures.

In select embodiments, the stored personalized NIL media of step (a) further includes a certificate of authenticity, verifying provenance of the personalized NIL media of step (a). This is to thwart counterfeiting of the college athlete's personalized NIL media, potentially diluting their brand and robbing them of revenue.

In select embodiments, the unique identifier is an embedded numeric tag including at least one of a device identifier or similar security feature. This numeric identifier feature may include metadata or Boolean logic specifically identifying the personalized NIL media, including for example the time and date of creation of the personalization, the location, (via GPS or similar means), of where the NIL media was personalized. In select embodiments, the unique identifier may also be a cyphertext or encrypted hash.

In select embodiments, the reward of step (f) includes a range of preapproved options from which the user selects a preferred reward.

In select embodiments, the system and method further includes identifying the social media platform of step (e) and offering varied, preapproved rewards during step (f), wherein the preapproved rewards are selectively associated with specific social media platforms. In yet another embodiment, the reward of step (f) includes a range of preapproved options from which the user selects a preferred reward.

Further disclosed is a non-transitory computer-readable media that stores data for short periods or in the presence of power, such as a memory device or Random Access Memory (RAM)] embodying a program executable in a computing device for providing electronic rewards to a user based on posting personalized NIL media on a social media platform, the method including: (a) communicating a request from a user's electronic device to a database having stored the personalized NIL media; (b) processing, by such a database, the request of step (a), the database subsequently communicating the requested personalized NIL media to the user's electronic device, the requested personalized NIL media having a unique identifier for distinguishing the personalized NIL media once it is shared on a social media platform; (c) storing the communicated personalized NIL media of step (b) on the user's electronic device; (d) accessing the social media platform with the user's electronic device; (e) sharing the personalized NIL media of step (c) from the user's electronic device to the social media platform such that other social media platform users can see or hear the personalized NIL media; (f) upon completion of step (e), communicating to the user's electronic device a reward for sharing the personalized NIL media on the social media platform while also communicating to the database the unique identifier recognizing the personalized NIL media; (g) after step (f), identifying the personalized NIL media of step (f) in the database by the unique identifier and the social media platform from which the personalized NIL media of step (f) was shared; and (h) determining a user's social media platform preferences by comparing the personalized NIL media of step (g) with demographic information associated with the user's electronic device.

Social media platforms may behave differently depending on where a user chooses to display personalized NIL media. By embedding the appropriate identifiers, personalized NIL media can unlock a variety of different rewards and incentives that cater to the demographics that are most popular within a particular social media platform once the personalized NIL media is posted and/or shared on a specific social media platform.

This unique code, numerical identifier, or specific metadata can identify the personalized NIL media. This could include the recipient's email address, which is often the unique identifier for logging into social media platforms like Facebook or Twitter. The personalized NIL media can include the recipient's email address as part of a digital watermark, making each piece of signed NIL media unique. The email address would be the first, and most common, unique identifier of each piece of NIL media sent out and (ultimately) posted to a social media platform.

X (formerly known as Twitter) for instance behaves differently than (Meta-owned) Facebook. X is generally used by most consumers for sharing quick sound bites or news items. Facebook meanwhile is generally reserved for longer content that is usually less time sensitive. While photographs and videos can be displayed on both social media platforms, users typically do so with very different purposes in mind.

Upon posting to Facebook, a personalized photo with an athlete could ‘unlock’ different actions, or allow certain gifts/rewards, than the same personalized NIL media posted to the social media platform Pinterest. These different rewards options help college athletes manage a worldwide fan base that is increasingly reliant on promotion through social media. Rewards and incentives can be changed based on national laws, limited partnerships, contractual obligations, or where/how the media is shared.

Social media platforms can also indicate preferred languages of each user. While the personalized NIL media from a college athlete may be signed in English, if the personalized NIL media is then posted to a social media platform in Mandarin or Italian, the athlete can account for this after the fact. Future rewards can be customized to reflect specific outreach partnerships or contracts based on language, location, ethnicities, and/or other demographics.

The system can also offer users within a specific demographic a range of options from which they may choose. If a user is not interested in reward Option 1, (perhaps a $5 Starbucks card), they may choose instead reward Option 2, (for instance a 10% discount on the college team's next home game). The user can opt for this or go with (if available) Option 3, an article of clothing from a retailer featuring the college athlete's NIL. The system allows athletes to personalize the loyalty program for long term users by adjusting the rewards.

Repeated postings on social media platforms can lead to additional or more valuable rewards as the user becomes a recognized promoter of the college athlete. Such a system has broad utility for athletes as streaming media becomes the cornerstone of modern entertainment distribution. Athletes must find and retain a user base over their academic and professional careers, preventing rivals from stealing their user (fan) base.

Embodiments of the invention can include one or more or any combination of the above features and configurations. Additional features, aspects and advantages of the invention will be apparent to those skilled in the art by practicing the invention as described herein. It is to be understood that both the foregoing general description and the following detailed description present various embodiments of the invention, and are intended to provide an overview or framework for understanding the nature of the invention as it is claimed. The accompanying drawings are included to provide a further understanding and constitute a part of this specification.

### BRIEF DESCRIPTION OF DRAWINGS

These and other features, aspects and advantages of the present invention are better understood when the following detailed description of the invention is read with reference to the accompanying drawings, in which:

FIG. 1 depicts a user sending personalized NIL media to a social media platform, (Facebook) from the user's electronic device.

FIG. 2 depicts a reward or incentive program using a first social media platform (e.g., social media platform A).

FIG. 3 depicts a reward or incentive program from the same personalized media that changes because the fan uses a second social media platform (e.g., social media platform B)

FIG. 4 depicts giving a reward through a social media platform by allowing the fan to select a reward from among several reward options; and

FIG. 5. depicts giving a reward or incentive that changes the offered options based on location, native language, or a combination thereof of the social media sites accordingly.

### DETAILED DESCRIPTION OF THE INVENTION

It is understood that each part of the block diagrams, or blocks in the block diagrams, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions specified in the diagrams.

In some embodiments, the functions noted in the blocks can occur out of the order noted in these illustrations. For example, two blocks shown in succession can in fact be executed concurrently, or the blocks can sometimes be executed in the reverse order, depending upon the functionality/acts involved. Furthermore, the embodiments of methods presented are provided by way of example in order to provide a more complete understanding of the system.

The inventive methods are not limited to the operations and logical flow presented herein. Alternative embodiments are contemplated in which the order of the various operations is altered and in which sub-operations described as being part of a larger operation are performed independently. The invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Similar reference numbers refer to like elements throughout the various drawings.

Generally, in terms of hardware architecture for the electronic devices disclosed below, computing device includes a processor, a memory, and one or more input and/or output (I/O) devices (or peripherals) that are communicatively coupled via a local interface. Local interface may be one or more buses or other wired or wireless connections, as is known in the art. Local interface may have additional elements, which are omitted for simplicity, such as controllers, buffers (caches), drivers, transmitters, and receivers to facilitate external communications with other like or dissimilar computing devices. Further, local interface may include address, control, and/or data connections to enable internal communications among the other computer components.

The processor is a hardware device for executing software, particularly software stored in memory. The processor can be any custom made or commercially available processor made by Intel Corporation, Phenom, Athlon or Advanced Micro Devices. In the case where computing device is a server, the processor may be from Intel or Advanced Micro Devices. The processor may also represent multiple parallel or distributed processors working in unison. The processor may also represent multiple processors located in a plurality of computing devices working in parallel, unison, or serial effort to achieve the disclosed methods.

Memory can have a distributed architecture where various components are situated remote from one another. Memory can include volatile memory elements including random access memory (RAM, such as DRAM, SRAM, and SDRAM, and/or nonvolatile memory elements including ROM, hard drive, flash drive, or CDROM. It may incorporate electronic magnetic, optical, and/or other types of storage media. These other components may reside on devices located elsewhere on a network or in a cloud server environment.

In the context of this document, a “computer-readable medium” may be any means that can store, communicate, propagate, or transport data objects for use by or in connection with the system. The computer readable medium may be for example, an electronic, magnetic, optical, electromagnetic, infrared, or semiconductor system, apparatus, device, propagation medium, or any other device with similar functionality. The system can be embodied in any type of computer-readable medium for use by or in connection with an instruction execution system or apparatus, such as a computer.

As further described below, disclosed are methods and systems of providing digital rewards to a user based on identifying when personalized NIL media is communicated to a social media platform, the method comprising: (a) communicating a request from a user's electronic device to a database having stored personalized NIL media; (b) processing, by the database, the request of step (a), the database subsequently communicating the requested personalized NIL media to the user's electronic device, the requested personalized NIL media having a unique mechanism for subsequently identifying the personalized NIL media once it is shared on a social media platform; (c) storing the communicated requested personalized NIL media of step (b) on the user's electronic device; (d) accessing the social media platform with the user's electronic device; (e) communicating the personalized NIL media of step (c) stored on the user's electronic device and sharing that personalized NIL media on the social media platform such that other users of the social media platform can also view the personalized NIL media; (f) after step (e), communicating into the user's electronic device a reward for sharing the personalized NIL media on the social media platform and also communicating to the database the unique identifier identifying the personalized NIL media; (g) after step (f), identifying, by the database, the personalized NIL media of step (f) by the unique identifier and the social media platform from to the personalized NIL media of step (f) was shared; and (h) determining a user's social media platform. In certain aspects, step (f) may be performed in real time and communicate the reward to the user's electronic device either concurrently or sequentially while communicating to the database the unique identifier identifying the personalized NIL media.

In some embodiments, the method consists of sequential steps (a)-(h). The stored personalized NIL media of step (a) is an electronic autograph, an electronic written message, an electronic audio message, an electronic video message, or a combination thereof provided by a college athlete. In some embodiments the video may be a short clip from a game or match, with the college athlete providing a personalized ‘voiceover’ addressing a particularly good catch, throw, hit, punch, or similar athletic moment. The video might similarly feature a personalized written message where the words fill in parts of screen area as the clip unfolds.

In some embodiments, the stored personalized NIL media of step (a) further comprises a certificate of authenticity verifying authenticity of the personalized NIL media of step (a).

In some embodiments, the certificate of authenticity comprises a 90% confidence level associated with writing samples, voice recognition, facial recognition, or a combination thereof of the college athlete. The college athlete's autograph or electronic written message, for example, must achieve, for example, at least a 90% confidence level based on an X,Y array coordinates including a statistical comparison of velocity between coordinates and relative position of points between coordinates. The audio message, video message, or combination thereof, if present, must achieve at least a 90% confidence level based on amplitude and frequency and/or facial recognition when compared to reference samples of the media provider.

In some embodiments, the unique identifier is an embedded tag comprising at least one of a numeric identifier or a security feature. This numeric identifier or security feature may include metadata, an encryption hash, digital watermark, or Boolean logic specifically identifying the personalized digital media including for example the time and date of creation of this NIL media, as well as the location of the device.

In some embodiments, the reward of step (f) includes a plurality of predetermined options from which the user selects a preferred reward.

In some embodiments, the systems and method further comprise identifying the social media platform of step (e) and offering varied, predetermined rewards during step (f), wherein the predetermined rewards are selectively associated with different social media platforms. In yet further embodiments, the reward of step (f) includes a range of predetermined options from which the user selects a preferred reward.

In theory, social media platforms and personalized NIL media should react differently depending on where a user chooses to display the personalized NIL media. By embedding the appropriate identifiers, personalized NIL media can unlock a variety of different rewards and incentives that cater to the demographics that are most popular within a particular social media platform once the personalized NIL media is shared.

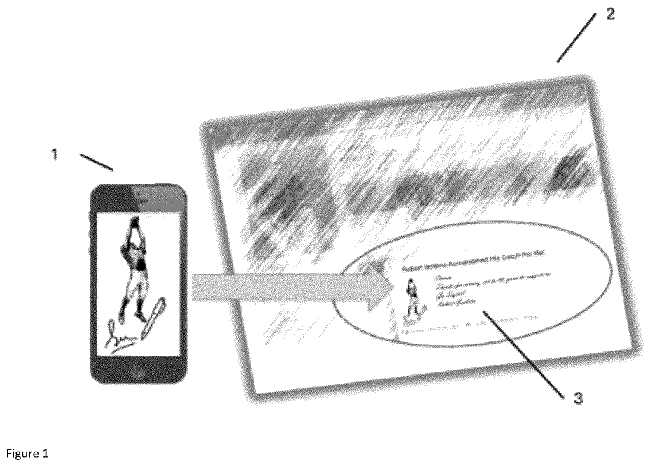

Referring to FIG. 1, a user sends personalized NIL media from their device 1 to a social media platform 2 where the personalized NIL media 3 is visible to any of the social media platform's other customers.

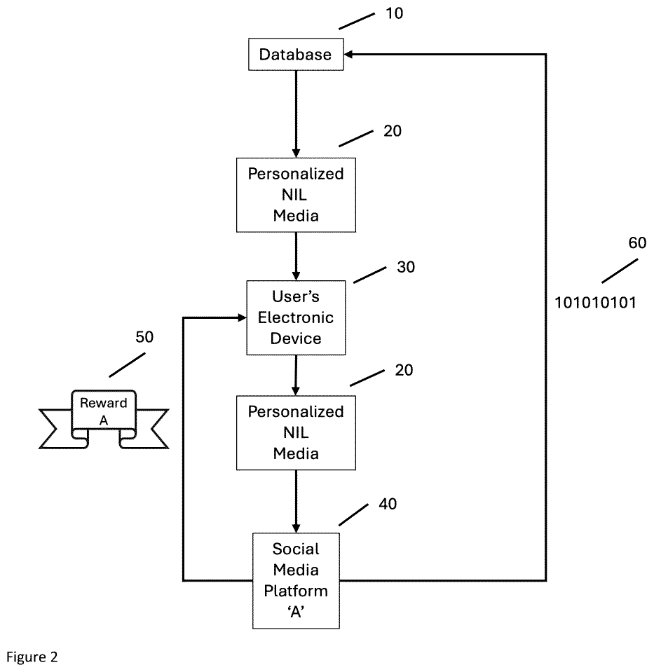

Referring to FIGS. 2-5, and specifically referring to the system and method of FIG. 2, a college athlete sends personalized NIL media to a user over a network with an embedded reward or incentive data included. The reward or incentive can be customized (or restricted) based upon the social media platform the user chooses to post it on. A database component 10 sends the NIL media over a network. The personalized NIL media 20 is delivered to the consumer's electronic device 30 where the personalized NIL media 20 can be viewed and enjoyed (photos, music, movies, etc.). The personalized NIL media 20 can also be subsequently shared on popular social media platforms 40 where the embedded reward or incentive is activated and a notice delivered to the user's electronic device 30. Based on the social media platform chosen, the user receives a reward or incentive 50.

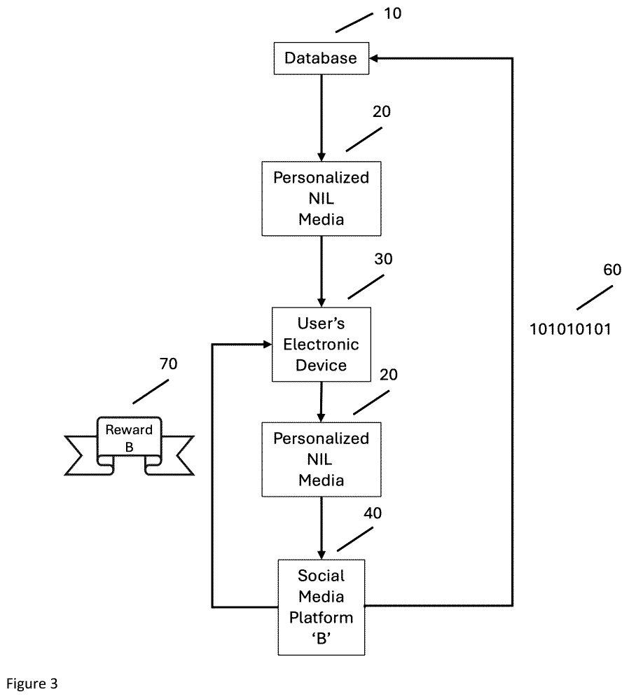

In select embodiments, referring to the system and method of FIG. 3, a college athlete sends personalized NIL media 20 to a user over a network with an embedded reward or incentive included that is deliver to the consumer's electronic device 30. The personalized NIL media 20 can also be shared on popular social media platforms 40 where the embedded reward or incentive is activated and a notice delivered to the user's electronic device 30. In view of the reward or incentive 50 shown in FIG. 2, the reward or incentive 70 of FIG. 3 can be customized (or restricted) based upon a different social media platform being chosen, (Platform B). If the fan posts the personalized NIL media to another social media platform the embedded reward or incentive could change again.

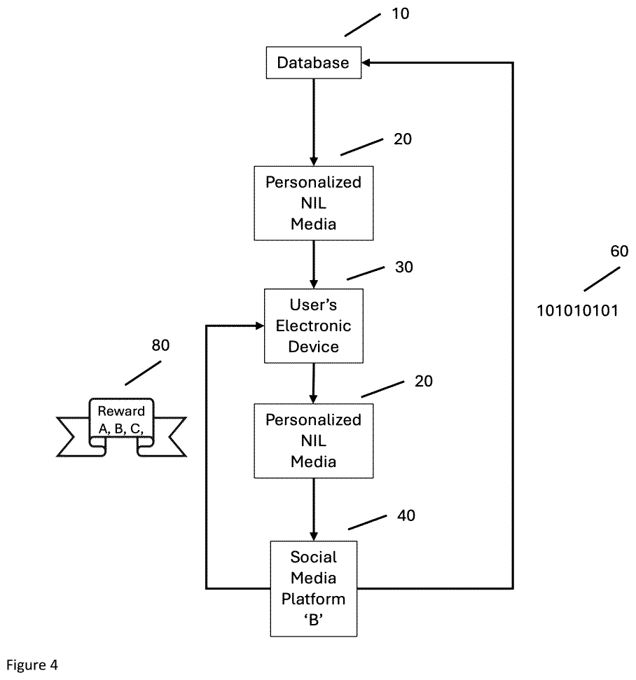

In select embodiments referring to the system and method of FIG. 4, a college athlete sends personalized NIL media to a user over a network with an embedded reward or incentive. A plurality of optional rewards or incentives 80 from which the user can select from is provided to allow the user to further customize the experience based on their own unique likes or preferences. The database component 10 of FIG. 4 sends the personalized NIL media 20 over a network. The personalized NIL media 20 is delivered to the consumer's electronic device 30 where the personalized NIL media can be viewed and enjoyed (photos, music, movies, etc). The personalized NIL media 20 can also be shared on a social media platform 40 where a plurality of embedded rewards or incentives 80 are activated and a notice delivered to the user's electronic device 30. Based on the user's personal preferences, the user can pick from among the plurality of options (A, B, C, etc.) 80 to choose from based on their specific likes, age appropriateness, age restrictions (alcohol for instance), or other control factors.

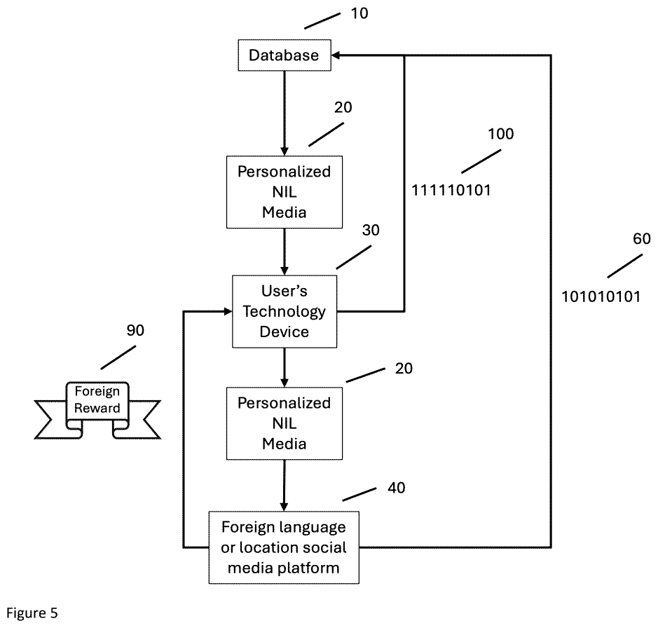

In a select embodiment referring to FIG. 5, the databased information on consumption is analyzed and provided to the college athlete. The database component 10 sends the personalized NIL media over a network. The personalized NIL media 20 is delivered to the user's electronic device 30 in a foreign country where the personalized NIL media 20 can be viewed and enjoyed (photos, music, movies, etc). The personalized NIL media 20 can also be shared on a social media platform 40 in another country. The embedded loyalty reward 90 recognizes the change in location, language, or other factors and adjusts to the cultural, legal, or regional norms of the social media platform's 40 location.

In each of the aspects provided above, identifiers 60 refer to a registry code for the embedded reward or incentive that is sent to a database, (the originating system or a stand-alone unit), to register the issuance of the reward or incentive and to further allow database 10 to determine which social media platforms the user is posting on. These identifiers may be used to determine a user's social media platform preferences. In select embodiments, when referring to FIG. 5, an additional identifier 100, which may include an additional registry code, is used to show a change to the originally intended reward or incentive that the fan has chosen. This will be updated in the database 10 (where the personalized NIL media originated) so the user's requested change is registered to one of the other options presented.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method of automatically adjusting the digital rewards to incentivize a user to post their personalized NIL media on a social media platform, the method comprising:
a. communicating a request from a user's electronic device to a database having stored NIL media approved for personalization;
b. processing, by the database, the request of step (a), the database subsequently communicating the request to the user's electronic device, the personalized NIL media having a unique identifier for subsequently identifying that specific NIL media once it is shared on a social media platform;
c. storing the sent personalized NIL media of step (b) on the user's electronic device;
d. accessing the social media platform with the user's electronic device;
e. communicating the personalized NIL media of step (c) stored on the user's electronic device to a social media platform and sharing the personalized NIL media on the social media platform such that other users of that platform can view the personalized NIL media;
f. after step (e), communicating in real time to the user's device a reward for sharing the personalized NIL media on the social media platform while concurrently communicating to the database the unique identifier detecting that specific NIL media;
g. after step (f), identifying, by the database, the personalized NIL media of step (f) by the unique identifier and the social media platform from which the personalized NIL media of step (f) was shared; and
h. correlating a user's preferred social media platform of step (g) with demographic information comprising at least one of age, education level, income, gender, location, language or any combination thereof.

2. The method of claim 1, wherein the method consists of sequential steps (a)-(h).

3. The method of claim 1, wherein the stored personalized NIL media of step (a) is an electronic autograph, an electronic personalized written message, a personalized audio message, a personalized audio message, or a combination thereof provided by a college athlete. The stored media can be a photograph, video clip, branded autograph page, or other media approved for the athlete's use.

4. The method of claim 3, wherein the stored personalized NIL media of step (a) further comprises a certificate of authenticity verifying the legitimacy of the stored personalized NIL media of step (a) to prevent counterfeiting.

5. The method of claim 3, wherein the certificate of authenticity comprises a 90% or higher confidence level associated with writing samples, voice recognition, facial recognition, or a combination thereof of the college athlete.

6. The method of claim 5, wherein the unique identifier is an embedded tag comprising at least one of a numerical identifier, encryption hash, or other security feature.

7. The method of claim 5, wherein the unique identifier is a nonsequential numerical identifier.

8. The method of claim 5, wherein the reward of step (f) includes a range of predetermined options from which the user selects a preferred reward.

9. The method of claim 5, further comprising identifying the social media platform of step (e) and offering varied, predetermined rewards during step (f), wherein the predetermined rewards are selectively associated with certain social media platforms.

10. A non-transitory computer readable medium embodying a software program executable in a computing device for providing electronic rewards to a user based on identifying personalized NIL media communicated to a social media platform comprising:
a. communicating a request from a user's electronic device to a database having stored NIL media available for personalization;
b. processing, by the database, the request of step (a), the database subsequently communicating the requested personalized NIL media to the user's electronic device, the requested personalized NIL media having a unique identifier for subsequently identifying the personalized NIL media once it is shared on a social media platform;
c. storing the communicated personalized NIL media of step (b) on the user's electronic device;
d. accessing the social media platform with the user's electronic device;
e. communicating the personalized NIL media of step (c) stored on the user's electronic device to the social media platform and sharing the personalized NIL media on the social media platform such that other users of the social media platform can view the personalized NIL media;
f. after step (e), communicating in real time to the user's electronic device a reward for sharing the personalized NIL media on the social media platform while concurrently communicating to the database the unique identifier identifying of the personalized NIL media;
g. after step (f), identifying, by the database, the personalized NIL media of step (f) by the unique identifier and the social media platform to which the personalized NIL media of step (f) was shared; and
h. determining a user's preferred social media platform(s) by comparing the personalized NIL media of step (g) with demographic information associated with the user's device comprising at least one of age, education level, income, gender, location, preferred language, or any combination thereof.
